(19) United States
(12) Patent Application Publication
(10) Pub. No.: US 2021/0182580 A1
(43) Pub. Date: Jun. 17, 2021

(54) SYSTEM AND METHOD FOR VALIDATION OF A PARKING SPOT

(71) Applicants: Denso International America, Inc., Southfield, MI (US); Denso Corporation, Kariya-city (JP)

(72) Inventor: Christian Dan Munte, Livonia, MI (US)

(21) Appl. No.: 16/712,097

(22) Filed: Dec. 12, 2019

(51) Int. Cl. G06K 9/00; G06K 9/32; G06Q 30/06

(52) U.S. Cl. CPC G06K 9/00812; G06Q 30/0635; G06K 9/3258

(57) ABSTRACT

A system for parking validation includes at least one sensor, at least one processor, and a memory device. The at least one sensor and the memory device are operably connected to the at least one processor. The memory device may include an image capture module, a text recognition module, and a parking determination module. The modules cause the at least one processor to obtain at least one image of from the at least one sensor, recognize text located within the at least one image, determine parking-related information from the text, determine at least one parking spot associated with the parking-related information, determine when the at least one parking spot associated with the parking-related information is at least one of available for parking, not available for parking, and available for parking with a voucher.

### TECHNICAL FIELD

The subject matter described herein relates, in general, to a system and method for detecting and validating a parking spot for a vehicle.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Vehicles, when not in use, are generally parked in a spot where parking is allowed. In some cases, the use of the parking spot has no restrictions. In other cases, there may be restrictions or even prohibitions against parking a vehicle in a certain spot. These restrictions may include restrictions relating to the status of the driver (e.g., expectant mother, handicap, disabled veteran, and the like), the time of day, status of the vehicle (e.g., delivery vehicle, emergency vehicle, or personal vehicle), etc. Additionally, certain restrictions may be lifted by purchasing a voucher for the right to park in the parking spot for a certain period of time.

### SUMMARY

This section generally summarizes the disclosure and is not a comprehensive explanation of its full scope or all its features.

In one embodiment, a system for parking validation includes at least one sensor, at least one processor, and a memory device. The at least one sensor and the memory device are operably connected to the at least one processor. The memory device may include an image capture module, a text recognition module, and a parking determination module. The modules cause the at least one processor to obtain at least one image of from the sensor, recognize text located within the at least one image, determine parking-related information from the text, determine at least one parking spot associated with the parking-related information, and determine when the at least one parking spot associated with the parking-related information is at least one of available for parking, not available for parking, and available for parking with a voucher.

In another embodiment, a method for parking validation includes the steps of obtaining at least one image of from a sensor, recognizing text located within the at least one image, determining parking-related information from the text, determining at least one parking spot associated with the parking-related information, and determining when the at least one parking spot associated with the parking-related information is at least one of available for parking, not available for parking, and available for parking with a voucher.

In yet another embodiment, a non-transitory computer-readable medium for parking validation and including instructions that when executed by at least one processor cause the at least one processor to obtain at least one image of from a sensor, recognize text located within the at least one image, determine parking-related information from the text, determine at least one parking spot associated with the parking-related information, and determine when the at least one parking spot associated with the parking-related information is at least one of available for parking, not available for parking, and available for parking with a voucher.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a general overview of the system and method for detecting and validating a parking spot;

FIG. 2 illustrates a freestanding parking sign and a parking sign that is integrated with the parking spot;

FIG. 3 illustrates a field-of-view of a scene captured by the system;

FIG. 4 illustrates a field-of-view of a scene captured by the system including several parking signs;

FIG. 5 illustrates a general overview of the system and method for detecting and validating a parking spot, where the parking spot is located within a parking lot;

FIG. 6 illustrates a field-of-view of a scene captured by the system that includes the parking lot of FIG. 5;

FIG. 7 illustrates a more detailed view of the system for detecting and validating a parking spot; and

FIG. 8 illustrates a method for detecting and validating a parking spot.

### DETAILED DESCRIPTION

A system and method for detecting and validating a parking spot includes a sensor, such as a camera, that has a field of view that may include a sign or some indicator indicating the allowance, restriction, and/or prohibition for parking a vehicle in a parking spot. The system and method may capture an image of the sign and extract text from the sign. The system and method may determine the allowance, restriction, and/or probation for parking a vehicle in an associated parking spot from the extracted text. If the vehicle wishes to park in the parking spot, the system and method may also be able to purchase a voucher if required to park in the parking spot.

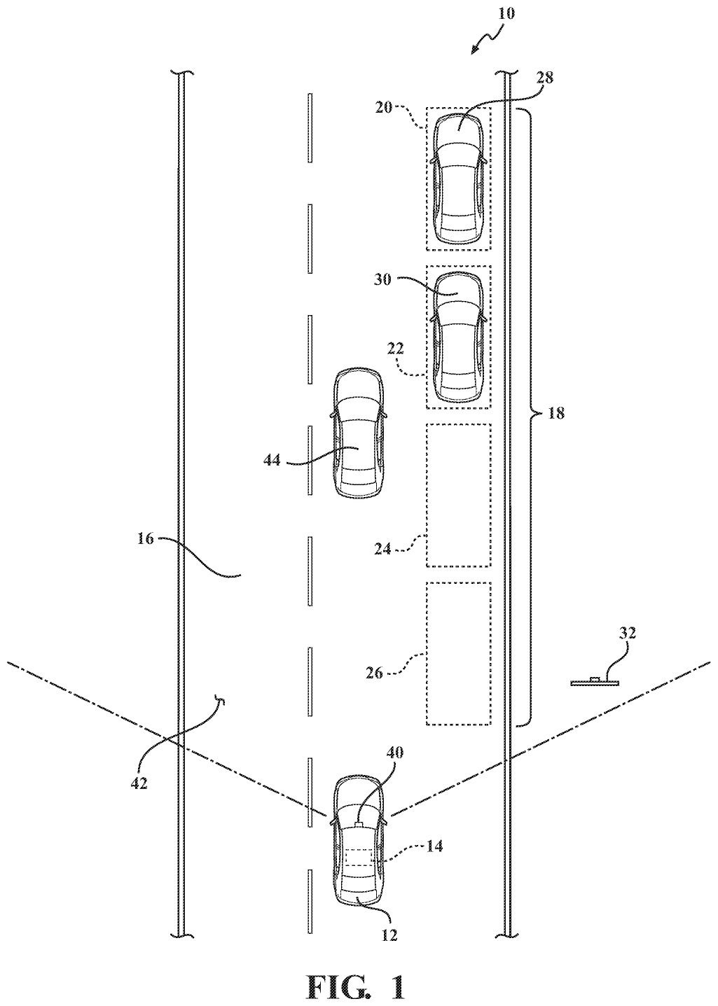

Referring to FIG. 1, a general overview of the system and method for detecting and validating a parking spot will be provided. FIG. 1 illustrates an environment 10 having a vehicle 12 that includes a system 14 for detecting and validating a parking spot. In addition to the vehicle 12, the environment 10 illustrates the vehicle 12 located on a street 16. The right side of the street 16 includes a parking area 18 for parking vehicles. The parking area 18, in this example, is street-side parking, where vehicles wishing to utilize the parking offered in the parking area 18 parallel park their vehicle. Of course, it should be understood, as will be explained more fully later in this description, that the parking area 18 may take any one of several different forms, such as parking lots, parking garages, and the like.

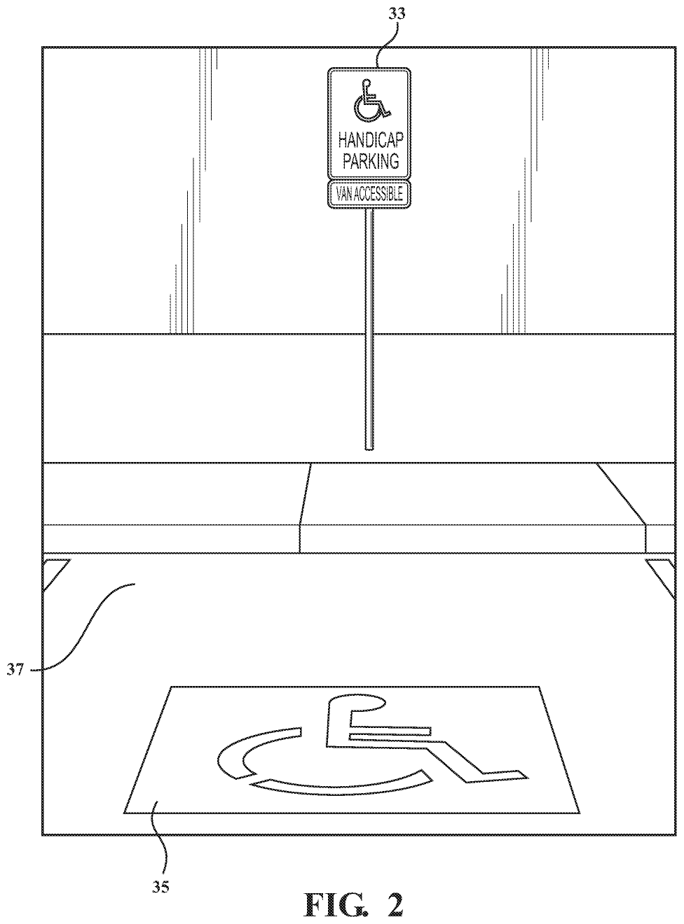

The parking area 18, in this example, includes four parking spots 20, 22, 24, and 26. The parking spots 20 and 22 are occupied by vehicles 28 and 30, respectively. The parking spots 24 and 26 are unoccupied. The environment 10 also includes a sign 32 that describes any allowances, restrictions, and/or prohibitions for utilizing the parking spots 20, 22, 24, and/or 26 of the parking area 18. In this example, the sign 32 is a street sign. However, it should also be understood that the sign 32 may take any one of several different forms. The sign 32 may be any type of sign that is capable of communicating allowances, restrictions, and/or prohibitions for utilizing a spot for parking. The sign 32 may be incorporated into the street 16 and/or parking space itself or could be a freestanding sign, as shown. For example, referring to FIG. 2, a sign 33 is shown as a freestanding sign, as well as another example of a sign 35 shown to be integrated within the parking spot and/or street. In this example, the sign 33 indicates that a vehicle may only park in the spot 37 associated with the sign 33 if the vehicle has a handicap-parking pass. The sign 35 also communicates the same information, where a vehicle may only park in the spot 37 associated with the sign 35 if the vehicle has a handicap-parking pass. In some situations, more than one sign may be utilized, such as both a freestanding sign and a sign that is integrated into a parking spot or street. In other situations, only one type of sign may be utilized.

Returning attention to the vehicle 12 of FIG. 1, the vehicle 12 may take any one of several different forms. In this example, the vehicle 12 is shown to be an automobile. However, it should be understood that the vehicle 12 may include other types of vehicles, such as trucks, sport utility vehicles, heavy-duty trucks, emergency vehicles, mining vehicles, agricultural vehicles, military vehicles, and the like. Moreover, the vehicle 12 could be any type of vehicle that is capable of transporting persons and/or objects from one location to another. Furthermore, it should be understood that the vehicle 12 may not be limited to land-based vehicles but could also include other types of vehicles as well, such as aircraft and seagoing vessels.

Furthermore, the vehicle 12 may be an autonomous vehicle. An autonomous vehicle may be a vehicle that requires little to no human intervention to properly operate the vehicle 12. Conversely, the vehicle 12 may be a non-autonomous vehicle that requires human input to operate the vehicle properly. Further still, the vehicle 12 may have multiple modes and may be able to function as both an autonomous vehicle in one mode and a non-autonomous vehicle in another mode or combination thereof.

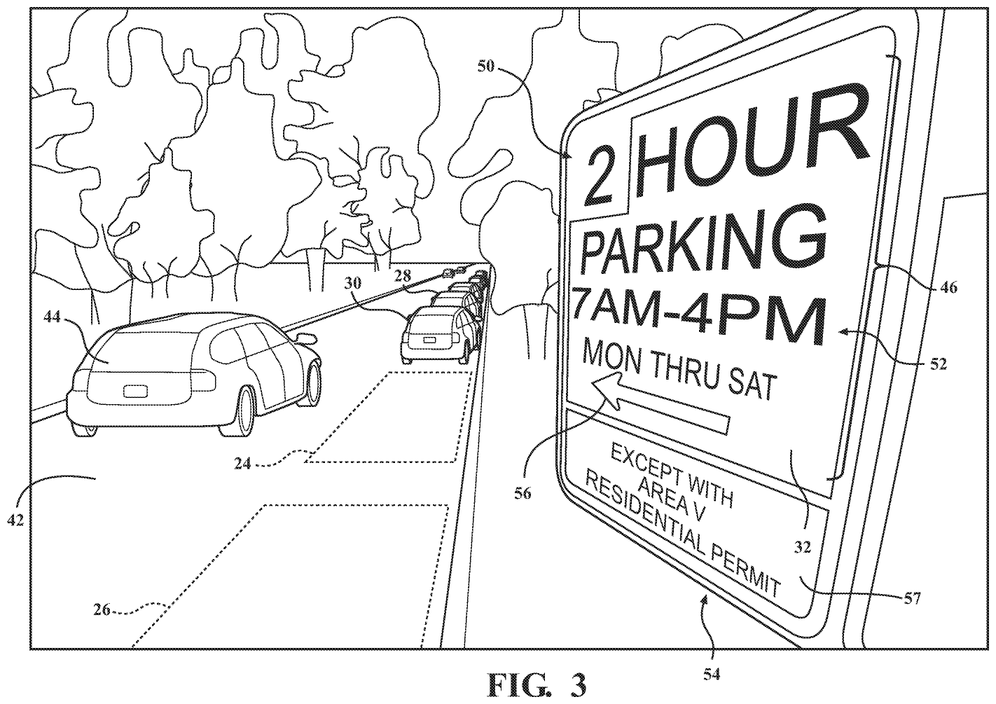

The vehicle 12 may have a sensor system 40 that includes at least one sensor that has a field-of-view 42. Referring to FIG. 3, the field-of-view 42 of FIG. 1 is shown. In this example, the field-of-view 42 includes the sign 32 and the available parking spots 24 and 26. The field-of-view also includes a moving vehicle 44 that is located forward of the vehicle 12, as well as the vehicle 28 and 30.

The sign 32 may include text 46 that relates to the allowance, restrictions, and/or prohibitions for utilizing the parking spots, such as parking spots 24 and 26. In this example, the text 46 is in the form of written words. However, it should be understood that the text 46 may take any one of several different forms, such as symbols that may be utilized instead of words or in combination with words to express any allowance, restrictions, and/or prohibitions. Additionally, it should also be understood that the text 46 may be readable only to a machine and may not be readily human-perceivable. For example, text 46 may take the form of a barcode (e.g., quick response (QR) code, datamatrix code, etc.) or other type of similar mechanism. Further still, the text 46 may be in the form of a radio transmission from a device, where the radio transmission includes information relating to the allowance, restrictions, and/or prohibitions of utilizing parking spots. One example of a device that transmits signals electronically could be a radio-frequency identification (RFID) type device. However, anyone of several different devices may be utilized.

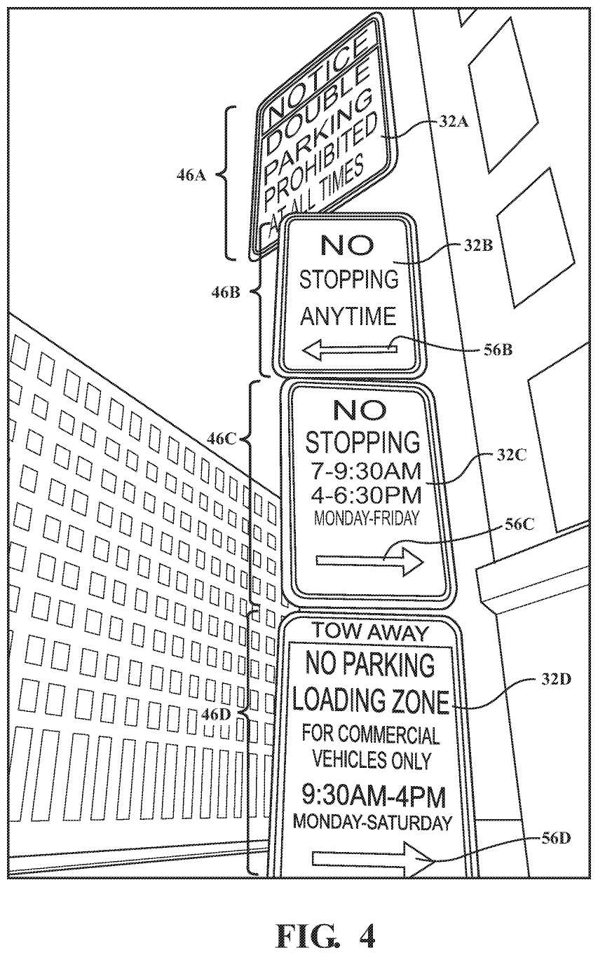

Furthermore, it should be understood that the sign 32 may be more than one sign and may be a collection of signs. For example, referring to FIG. 4, illustrated are signs 32A, 32B, 32C, and 32D having text 46A, 46B, 46C, and 46D, respectively. In this example, the sign 32A includes text 46A related to a prohibition of double parking at all times. The text 46A of the sign 32A relates to the signs 32B, 32C, and 32D. As such, the parking associated with the signs 32B, 32C, and 32D prohibits double parking in parking spots associated with those signs.

The sign 32B has text 42B indicating no stopping at any time for one set of parking spots. The signs 32C and 32D both relate to another set of parking spots. Here, the sign 32C has text 46C that states no stopping between 7:00 AM to 9:30 AM and 4:00 PM to 6:30 PM, Monday through Friday. The sign 32D also puts additional prohibitions on the parking spots associated with the sign 32C. In this example, the text 46D indicates that the spots are associated with a loading zone for commercial vehicles only between 9:30 AM to 4:00 PM, Monday through Saturday. As such, the system 14 may determine which signs 32A, 32B, 32C, and/or 32D are associated with which parking spots. In this example, the signs 32A, 32C, and 32D relate to one set of parking spots, while the signs 32A and 32B relate to another set of parking spots. As such, the sign 32A relates to all the signs 32B, 32C, and 32D. The system 14 may be able to capture images of one or more signs, such as the signs 32A, 32B, 32C, and/or 32D and extract text, indicators, and/or images that indicate which parking spots relate to the signs 32A, 32B, 32C, and/or 32D. For example, indicators could include the waymarkers 56B, 56C, and/or 56D from the signs 32B, 32C, and/or 32D, respectively. The waymarkers 56B, 56C, and 56D may point to which parking spots the parking information is referring to. The system 14 may then determine which parking spots are associated with which signs based on the waymarkers 56B, 56C, and/or 56D.

Returning to FIG. 3, in this example, the text 46 includes an indication regarding a time duration 50 that one may park their vehicle in the parking spots 24 or 26, a time of day restriction 52 indicating the hours of the day and/or days that one may park their vehicle in the parking spots 24 and 26, and exceptions 54 regarding if there any exceptions to the restriction 52 or time duration 50. The text 46 also includes a waymarker 56 that indicates the general location of the parking spots that relate to the text 46 of the sign 32.

In this example, the text 46 indicates that a vehicle may park for two hours between the hours of 7:00 AM to 4:00 PM, Monday through Saturday. The text 46 also indicates that these restrictions do not apply if you have a residential permit. Furthermore, the text 46 provides the waymarker 56 (e.g., to the left of the sign 32) indicating the general location of the parking spots 20, 22, 24, and 26 that are related to the text 46 of the sign 32.

As will be explained in greater detail in the paragraphs that follow, the system 14 of the vehicle 12 may capture information from the sign 32 and extract text within the sign 32. The system may determine any parking spots associated with the sign 32 and any allowances, restrictions, and/or prohibitions for parking in the parking spots associated with the sign 32. Furthermore, the system may have additional capabilities that allow for the purchase of a voucher that allows one to park in a parking spot if required, as indicated in the text extracted from the sign 32.

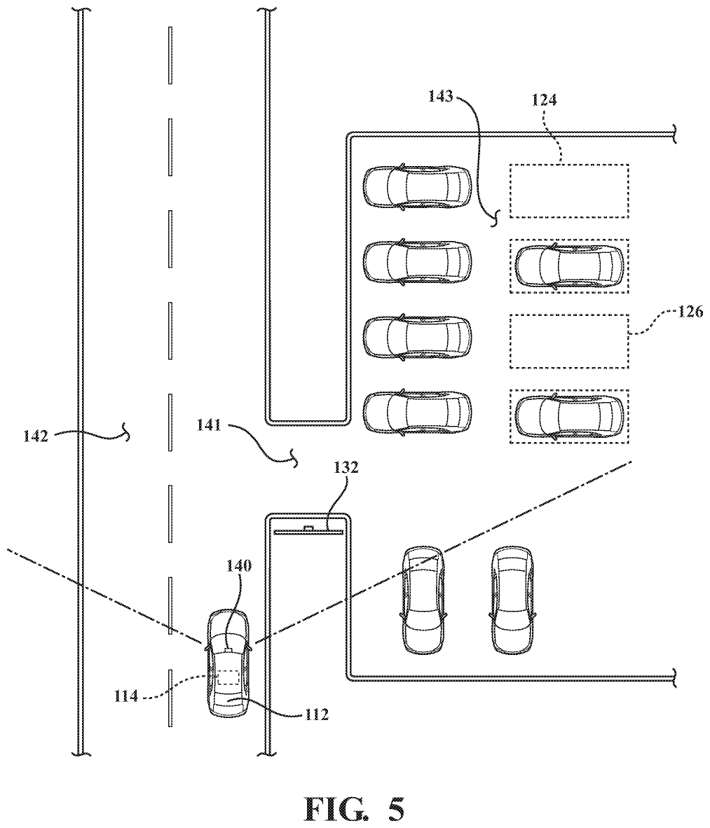

It should be understood that the system 14 of the vehicle 12 may be utilized in other types of situations that involve parking, such as parking lots and parking structures and is not just limited to street-side parking. For example, referring to FIG. 5, a vehicle 112 having a system 114 is shown. It should be understood that in this figure, like reference numerals have been utilized to refer to like items. As such, the vehicle 112 having the system 114 of FIG. 5 may be similar to the vehicle 12 having the system 14 of FIG. 1, respectively.

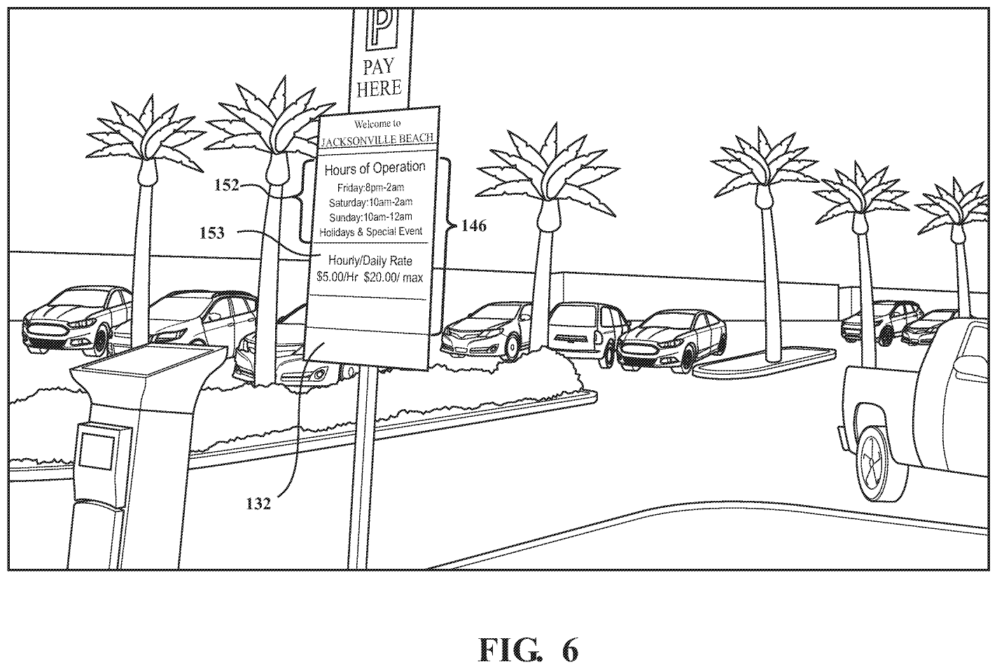

In this example, the vehicle 112 is located on a road 142. The road 142 leads to an entrance 141 of a parking lot 143 that has a plurality of spaces, including available parking spots 124 and 126 that are available for parking. In addition, the parking lot 143 also includes a sign 132 that provides details regarding parking within any of the spots located within the parking lot 143. For example, referring to FIG. 6, the sign 132 includes text 146 that indicates the hours of operation 152 and a requirement to pay information 153 (e.g., purchase a voucher) to utilize any of the open spots, such as parking spots 124 and 126. The system 114 may capture an image using a sensor system 140 of the sign 132, extract any text within the sign 132, and determine if parking is available and/or any requirements for a voucher. In this example, the system 114 determines the hours of operation of the parking lot and the requirement for payment of a voucher. As stated before, the system 114 may perform payment of the voucher to allow the vehicle 112 to park within the parking lot 143.

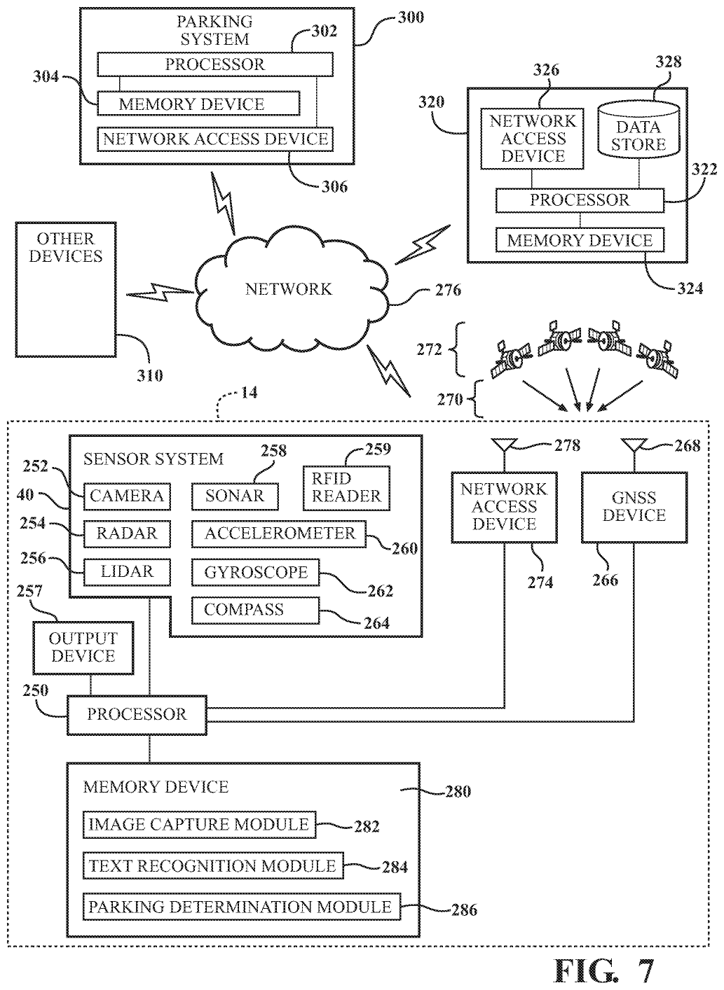

Referring to FIG. 7, a more detailed view of the system 14 is provided. In this example, the system 14 includes a processor 250. The processor 250 may be a single processor or may be multiple processors working in concert. If multiple processors are utilized, the processors may be located within the system 14 or may be located outside the system 14 in a distributed fashion. The sensor system 40, which may correspond to the sensor system 40 of FIG. 1 and/or the sensor system 140 of FIG. 5, may include one or more sensors, for sensing the environment located around the vehicle 12, such as signs 32 and 132.

Here, the sensor system 40 includes one or more cameras 252, a radar sensor 254, a LIDAR (Light Detection and Ranging) sensor 256, a sonar sensor 258, and an RFID reader 259. These sensors may be capable of sensing the environment surrounding the vehicle 12. It should be understood that the sensor system 40 is but one example of a sensor system and different types and/or combinations of sensors may be utilized, not just those described.

In one example, the camera 252 may be utilized to capture images of the signs 32 and/or 132 and may provide this information to the processor 250, where the processor 250 may extract text and or other symbols from the signs 32 and/or 132. With regards to the RFID reader 259, the signs 32 and/or 132 may be embedded with an RFID transmitter that transmits information related to the signs 32 and/or 132 to the RFID reader 259.

The radar sensor 254 and/or the sonar sensor 258 may locate objects by receiving an echo of a signal that is bounced off one or more objects. The LIDAR sensor 256 utilizes reflected light that is reflected from one or more objects. Depending on the size, shape, and other identifying information (e.g. braille text, raised text, etc.), the radar sensor 254, the sonar sensor 258, and/or the LIDAR sensor 256 may be able to extract information from detected objects, such as the signs 32 and/or 132.

In addition to these sensors, the sensor system 40 may also include other sensors, such as an accelerometer 260, a gyroscope 262, and a compass 264, which may be utilized to determine the movement of the system 14 within the vehicle 12 or any other device which the system 14 is located within.

The system 14 may also include a Global Navigation Satellite System (GNSS) device 266, which may be in communication with an antenna 268. The GNSS device 266 may be a satellite navigation system that provides autonomous geo-spatial positioning with global coverage. The GNSS device 266 may include any one of several different GNSS systems, such as GPS (Global Positioning System), GLONASS (Globalnaya Navigatsionnaya Sputnikovaya Sistema), Galileo, Beidou, or other regional systems. The GNSS device 266 may be connected to an antenna 268 that is capable of receiving one or more signals 270 from one or more satellites 272. Based on the one or more signals 270 from one or more satellites 272, the GNSS device 266 may determine the relative location of the system 14. This relative location may be in the form of a coordinate system that may indicate the latitude, longitude, and/or altitude of the vehicle 12, or any other type of system, that has the GNSS device 266 installed within.

The system 14 may also include a network access device 274 that is in communication with the processor 250. The network access device 274 may be an electronic circuit that connects, either automatically or manually, the processor 250 to a network. The network access device 274 may be in communication with the processor 250 using one of a variety of different networks and/or communication protocols. Examples may include a controller area network (CAN), local area network (LAN), media orientated systems transport (MOST), or any other network capable of providing an electronic communication pathway between the network access device 274 and the processor 250.

The network access device allows the system 14 and, therefore, the processor 250 to communicate with one or more devices that are connected or in communication with a network 276. The network 276 may be a distributed network such as the Internet, cloud-computing device, or any other device that may be in communication with the network 276. The network access device 274 may be in communication with the network 276 via the use of an antenna 278 that is in communication with the network access device 274. In one example, the antenna 278 may be a cellular antenna configured to connect with one or more cellular networks, such as analog cellular networks and/or digital cellular networks, such as 2G, 3G, 4G, 5G networks and future iterations thereof. The antenna 278 may also be other types of antennas or combinations thereof, such as antennas that are configured to connect with Wi-Fi networks (IEEE 802.1X), Bluetooth networks, and/or V2X networks such as V2V, V2C, V2I, and combinations thereof. As will be explained in greater detail, the network access device 274 allows the system 14 to communicate with other devices to perform any one of several different functions, such as purchasing a voucher to allow a vehicle to park within a parking spot.

The system 14 may also include a memory device 280 for storing digital information that is either utilized or generated by the processor 250. As such, the memory device 280 may be any type of memory device capable of storing information, such as a solid-state memory device, magnetic storage device, optical storage device, and the like. Furthermore, it should be understood that the memory device 280 may be multiple memory devices of the same or even different types distributed throughout the system 14 or even distributed outside the system 14. In addition, the memory device 280 may be integrated within the processor 250 or may be separate from the processor 250 as shown.

In this example, the memory device 280 includes an image capture module 282, a text recognition module 284, and a parking determination module 286. Each of the modules 282, 284, and/or 286 may contain instructions that cause the processor 250 to perform any one of several different methodologies disclosed in this specification. In one example, the image capture module 282 includes instructions that cause the processor 250 to capture an image using one or more sensors making up the sensor system 40. In one example, the image capture module 282 causes the camera 252 to capture images, such as images of the signs 32 and/or 132. These captured images may be stored within the memory device 280 or elsewhere.

The text recognition module 284 may cause the processor 250 to recognize text from an image captured by the camera 252. In this example, the text recognition module 284 causes the processor 250 to recognize text, such as text 46 and/or 146. The parking determination module 286 may cause the processor 250 to determine the parking spots associated with any signs captured by the image capture module 282, as well as determining the availability of parking based on text recognized by the text recognition module 284. As stated previously, the processor 250 of the system 14 may determine the presence of text, such as text 46 that may relate to whether a parking spot is available, the duration of the parking, the location of the parking spots associated with the text 46, and any allowances, restrictions, and/or prohibitions for utilizing the parking spots. Based on the determination regarding any allowances, restrictions, and/or prohibitions for utilizing the parking spots, the system 14 will determine whether a parking spot is available if a voucher is purchased. The parking determination module 286 causes the processor 250 to determine from the text if any voucher can be purchased.

If a voucher can be purchased to allow for parking, the system 14 may communicate with a parking system 300 by the network 276 utilizing the network access device 274. In one example, the parking system 300 may have a processor 302 in communication with a memory device 304 and a network access device 306 that allows for the parking system 300 to communicate with the network 276 and, therefore, the system 14. The parking system 300 may be an electronic system that can sell vouchers for utilizing parking spaces in one or more spots. The sign 32 and/or 132 may provide information regarding which parking system 300 to purchase a voucher from. In one example, the parking determination module 286 may electronically purchase a voucher from the parking system 300. If the purchasing of a voucher is successful, this may allow the vehicle that is associated with the system 14 the ability to park within a parking spot that is associated with the voucher that was recently purchased.

The parking determination module 286 may also cause the processor 250 to communicate with other devices that are in communication with the network 276. In one example, if it is determined that the voucher that has been purchased by the parking system 300 has a temporal limit, the system 14 may notify another device 310, which may be a mobile device of a person responsible for the vehicle containing the system 14 or otherwise associated with the system 14. For example, if it is determined that the time limit for parking a parking spot is about to expire or has expired, the system 14 may communicate with the other device 310 to inform the appropriate person that the vehicle may be parking in a spot in which it no longer has permission to park within. In one example, the other device 310 may be a mobile phone, tablet computer, a notebook computer, or other computing device that incorporates the system 14. The system 14 may communicate with the user to indicate that their parking is about to expire. The user may be able to indicate via the device 310 to purchase additional parking vouchers if possible, to avoid any ticketing of the vehicle.

The system 14 may also communicate with other types of systems, such as a central server 320 that is capable of collecting information regarding parking spots. For example, the central server 320 may include a processor in communication with the memory device 324 and a network access device 326. The network access device 326 allows the central server 320 to communicate with the network 276 and, therefore, the system 14. In addition, the central server 320 may include a data store 328. The data store 328 is, in one embodiment, an electronic data structure such as a database that is stored in the memory device 324 or another memory and that is configured with routines that may be executed by the processor 322 for analyzing stored data, providing stored data, organizing stored data, and so on.

The central server 320 may receive information regarding parking spot information from the system 14 and other systems like the system 14 installed in other vehicles and/or devices. As stated before, the system 14 can be found in numerous other devices, such as other vehicles and/or other devices, such as mobile phones, tablet devices, notebook computers, and the like. The central server 320 may collect information from the system 14 and systems like the system 14 regarding the location of parking spots. Based on this collected information, the central server 320 may be able to determine an overall confidence interval that the detected parking spot is an actual parking spot by using crowdsourcing type information collected from the system 14 and systems like the system 14. This information may then be provided back to the system 14 to confirm that the parking spot is indeed a parking spot or perhaps request that the system 14 double-check to confirm that the parking spot is indeed available. The same could be true regarding information collected from signs, such as signs 32 and 132. The central server 320 may collect information regarding signs collected from the system 14 and systems like the system 14.

The central server 320 may determine what the signs 32 and/or 132 communicate by reviewing what the system 14 and systems like the system 14 have already determined. An overall confidence interval may be determined, indicating what information the signs 32 and/or 132 actually state. As such, if the system 14 determines that the sign 32 and/or 132 is indicating something different than what was stored by the central server 320, the central server 320 could inform the system 14 of the potential incorrect interpretation of the signs 32 and/or 132 and request that the system 14 performs further analysis to determine what information the sign is attempting to communicate.

As stated before, the system 14 could be located within a vehicle, such as a vehicle 12. However, it should be understood that the system 14 may be located within any other suitable device. For example, the system 14 could be a mobile device that may perform any of the functionalities described in the present disclosure.

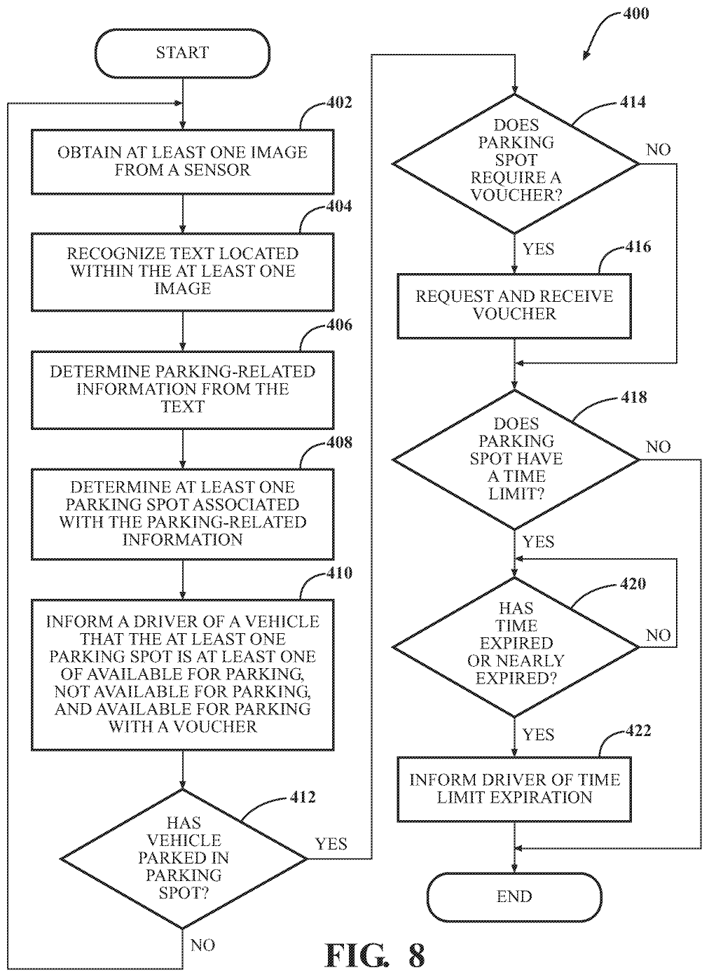

Referring to FIG. 8, one example of a method 400 for parking validation will be discussed from the perspective of the system 14 of FIGS. 1 and 7. While the method 400 is discussed in combination with the vehicle 12, it should be appreciated that the method 400 is not limited to being implemented within the vehicle 12 and is instead one example of a system that may implement the method 400. For example, as stated above, the method 400 may be utilized by a mobile device.

The method 400 begins at step 402, where the image capture module 282 causes the processor 250 to obtain at least one image from the sensor system 40. The at least one image may be captured by the camera 252 of the sensor system 40. In step 404, the text recognition module 284 causes the processor 250 to recognize text located within the captured image. Here, the captured image may include text located on the sign, such as the sign 32 shown in FIG. 3. The text recognition module 284 may be able to extract text from the image captured in step 402.

In step 406, the parking determination module 286 causes the processor 250 to determine parking-related information from the text extracted in step 404. The parking-related information may include information regarding any allowances, prohibitions, and/or restrictions for parking in one or more parking spots. In step 408, the parking determination module 286 causes the processor 250 to determine at least one parking spot associated with parking-related information previously mentioned in step 406. For example, the parking determination module 286 determines which parking spots are associated with the parking-related information determined in step 406. This may be determined by utilizing one or more indicators in a sign captured from the sensor, as discussed in step 402. For example, referring back to FIG. 3, the indicator could include the waymarker 56, pointing to which parking spots the parking information is referring to.

In step 410, the parking determination module 286 may cause the processor 250 to inform the driver or another system that controls the vehicle that the parking spot associated with parking-related information is either available for parking, not available for parking and/or available for parking with a voucher. This information may be provided to a driver via an output device 257 (as shown in FIG. 7) or other devices 310 that may be in communication with the processor 250. The output device 257 may take any one of a number of different forms and may be an audible or visual output device, such as a speaker or display or combination thereof. Furthermore, it should be understood that instead of providing information to the driver of the vehicle, information could be provided to an autonomous vehicle system that functions to operate the vehicle instead of, or in addition to, a human driver.

In step 412, the parking determination module 286 causes the processor 250 to determine whether the vehicle 12 has parked in the parking spot. If the vehicle 12 has not parked in the parking spot, the method will return to step 402. Otherwise, the method will proceed to step 414. The vehicle 12 may determine the availability of a parking spot that requires the purchase of a voucher. As such, in step 414, the parking determination module 286 determines whether the parking spot requires a voucher. This can be determined by utilizing information on the sign, such as the information 153 shown on sign 132 of FIG. 6. If no voucher is required, the method will proceed to step 418. However, if a voucher is required, this method 400 will proceed to step 416, where the parking determination module 286 may cause the processor 250 to request and receive a voucher. This may occur by having the processor 250 communicate with parking system 300 via the network 276. Here, the processor 250 may request a voucher and may potentially pay for a voucher using any one of several different payment These different payment protocols could include electronic fund transfer protocols, such as debit transfers, credit card transfers, automatic teller machine (ATM) transfers, electronic check, automated clearinghouse, real-time gross settlement systems, and the like. For example, the system 14 may have credit card information or other account information associated with the vehicle 12 that allows the system 14 and/or the driver the vehicle 12 to purchase a voucher from the parking system 300. In another example, the central server 320 could also include information regarding payment methods and include a credit system to communicate with parking system 300.

In step 418, the parking determination module 286 determines whether the parking spot has a time limit associated with the parking spot. Essentially, the time limit associated with the parking spot could include a duration that one is allowed to park their vehicle in the parking spot. For example, as indicated in FIG. 3, the sign 32 indicates duration information 50 or other time-related information in the text 46. If there is no time limit to the parking spot, the method 400 may end or may return to step 402.

However, if the parking spot does have a time limit, the method proceeds to step 420, where the parking determination module 286 causes the processor 250 to determine if a time limit associated with the parking spot has expired or has nearly expired. The term expired may mean that the vehicle 12 has either parked in the parking spot up to or past a limited duration (i.e., two hours). Nearly expired may mean sometime before the expired time. Nearly expired may include five, ten, etc. minutes or some other time before the expiration time that the vehicle 12 is allowed to park. If the time limit has not expired or is not nearly expired, the method 400 will return to step 420. Otherwise, the method 400 will proceed to step 422, where the system 14 may inform the driver of the time limit expiration. For example, the parking determination module 286 may cause the processor 250 to inform the driver carrying a mobile device, such as the device 310, that the parking for their vehicle 12 may be expiring soon or has already expired. By doing so, the driver may be able to purchase additional parking time or will have the ability to timely move the vehicle to another spot to not incur any penalties.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer-executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an application-specific integrated circuit (ASIC), a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. A module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for parking validation, the system comprising:
at least one sensor;
at least one processor operably connected to the at least one sensor;
a memory device operably connected to the at least one processor;
the memory device comprising an image capture module having instructions that when executed by the at least one processor cause the at least one processor to obtain at least one image of from at least one sensor;
the memory device comprising a text recognition module having instructions that when executed by the at least one processor cause the at least one processor to recognize text located within the at least one image; and
the memory device comprising a parking determination module having instructions that when executed by the at least one processor cause the at least one processor to:
determine parking-related information from the text,
determine at least one parking spot associated with the parking-related information, and
determine when the at least one parking spot associated with the parking-related information is at least one of available for parking, not available for parking, and available for parking with a voucher.

2. The system of claim 1, wherein the parking determination module further comprises instructions that when executed by the at least one processor cause the at least one processor to transmit a request for purchasing the voucher to a voucher purchasing system and receive the voucher from the voucher purchasing system.

3. The system of claim 1, wherein the at least one sensor is at least one camera mounted to a vehicle.

4. The system of claim 1, wherein the parking determination module further comprises instructions that when executed by the at least one processor cause the at least one processor to determine a parking time limit associated for the at least one parking spot from the parking-related information and inform a driver when the parking time limit expires.

5. The system of claim 4, wherein the parking determination module further comprises instructions that when executed by the at least one processor cause the at least one processor to inform the driver when the parking time limit expires at a predetermined time before the parking time limit expires when a vehicle is parked in the parking spot.

6. The system of claim 1, wherein the parking determination module further comprises instructions that when executed by the at least one processor cause the at least one processor to determine a location of the at least one parking spot and transmit to a central server the location of the at least one parking spot and parking-related information associated with the at least one parking spot.

7. The system of claim 1, wherein the parking determination module further comprises instructions that when executed by the at least one processor cause the at least one processor to determine a location of the at least one parking spot and obtain from a central server parking-related information associated with the at least one parking spot.

8. A method for parking validation comprising the steps of:
obtaining at least one image of from a sensor;
recognizing text located within the at least one image;
determining parking-related information from the text;
determining at least one parking spot associated with the parking-related information; and
determining when the at least one parking spot associated with the parking-related information is at least one of available for parking, not available for parking, and available for parking with a voucher.

9. The method of claim 8, further comprising the steps of:
transmitting a request for purchasing the voucher to a voucher purchasing system; and
receiving the voucher from the voucher purchasing system.

10. The method of claim 8, wherein the sensor is at least one camera mounted to a vehicle.

11. The method of claim 8, further comprising the steps of:
determining a parking time limit associated for the at least one parking spot from the parking-related information; and
informing a driver when the parking time limit expires.

12. The method of claim 11, further comprising the steps of informing the driver when the parking time limit expires at a predetermined time before the parking time limit expires when a vehicle is parked in the parking spot.

13. The method of claim 8, further comprising the steps of:
determining a location of the at least one parking spot; and
transmitting to a central server the location of the at least one parking spot and parking-related information associated with the at least one parking spot.

14. The method of claim 8, further comprising the steps of:
determining a location of the at least one parking spot; and
obtaining from a central server parking-related information associated with the at least one parking spot.

15. A non-transitory computer-readable medium for parking validation and including instructions that when executed by at least one processor cause the at least one processor to:
obtain at least one image of from a sensor;
recognize text located within the at least one image;
determine parking-related information from the text;
determine at least one parking spot associated with the parking-related information; and
determine when the at least one parking spot associated with the parking-related information is at least one of available for parking, not available for parking, and available for parking with a voucher.

16. The non-transitory computer-readable medium of claim 15, further including instructions that when executed by at least one processor cause the at least one processor to:
transmit a request for purchasing the voucher to a voucher purchasing system; and
receive the voucher from the voucher purchasing system.

17. The non-transitory computer-readable medium of claim 15, further including instructions that when executed by at least one processor cause the at least one processor to:
determine a parking time limit associated for the at least one parking spot from the parking-related information; and
inform a driver when the parking time limit expires.

18. The non-transitory computer-readable medium of claim 17, further including instructions that when executed by at least one processor cause the at least one processor to inform the driver when the parking time limit expires at a predetermined time before the parking time limit expires when a vehicle is parked in the parking spot.

19. The non-transitory computer-readable medium of claim 15, further including instructions that when executed by at least one processor cause the at least one processor to:
determine a location of the at least one parking spot; and
transmit to a central server the location of the at least one parking spot and parking-related information associated with the at least one parking spot.

20. The non-transitory computer-readable medium of claim 15, further including instructions that when executed by at least one processor cause the at least one processor to:
determine a location of the at least one parking spot; and
obtain from a central server parking-related information associated with the at least one parking spot.
